(19) United States
(12) Patent Application Publication
(10) Pub. No.: US 2025/0232771 A1
(43) Pub. Date: Jul. 17, 2025

(54) INTERACTIVE TEXTUAL SYSTEM USING VISUAL GESTURE RECOGNITION

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/412,679

(22) Filed: Jan. 15, 2024

(51) Int. Cl. G10L 15/25; G10L 15/183; G10L 15/22

(52) U.S. Cl. CPC G10L 15/25; G10L 15/183; G10L 15/22

(57) ABSTRACT

A system and a method for conducting a conversation comprising text using prompts, a computer vision model processing visual input, and a neural network based generative language model. The method may be used as a tutor for education or training, an examination system, for sales conversations, customer support and the like. The method is based on a multimodal model comprising a language model and a computer vision model which acquires visual cues.

### FIELD AND BACKGROUND OF THE INVENTION

The present invention, in some embodiments thereof, relates to user input classification, and, more particularly, but not exclusively, to combining textual and visual input from a user.

User interaction may be based on dedicated button, text, voice, gesture recognition and/or the like.

Automated conversation such as textual dialog systems are implemented in many contexts, such as training, testing, product recommendation, customer service, virtual sales agents, and the likes. People may be unaware of their emotional state and its implications on the manner in which they interact, or deliberately strive to disparage or conceal their feelings.

Automated conversation may apply Natural Language Processing (NLP) using various machine learning methods and platforms to interpret user intent, context, and nuances in language. Contextual management allows chatbots and virtual assistants to maintain longer and more meaningful conversations, based on previous interactions.

Chatbots and virtual assistants may be personalized by leveraging user data and preferences, by processing feedback, by tuning or by applying recommendations system methods.

Some systems incorporate systems incorporate sentiment analysis technology to detect users' emotional states based on their language and tone.

Some systems aim for omnichannel experience using a plurality of platforms and devices, which may support seamless switching between devices while continuing their conversations. Multiple modes of communication, such as text, images, and voice may be used to enrich the user experience.

Neural network may be used for text classification and generation, as well as computer vision, such as facial identification, facial expression classification pose estimation, and gesture recognition. Some neural network-based system such as transformers may be used for multimodal embedding.

### SUMMARY OF THE INVENTION

It is an object of the present invention to provide a system and a method for conducting interaction comprising at least one prompt, based on processing textual content from a user and visual input pertaining to the user using a model comprising conversational language model.

According to an aspect of some embodiments of the present invention there is provided a method for evaluating understanding in a textual content, comprising:
acquiring a textual content from a user, using a virtual human interaction agent;
acquiring a visual input pertaining to the user from an image sensor;
using at least one processing circuitry for executing at least one computer vision analysis function to infer a textual indication from the visual input, wherein the visual input corresponding to a non-verbal cue; and
generating at least one prompt by processing the textual content and the textual indication using the at least one processing circuitry executing an interaction model.

According to an aspect of some embodiments of the present invention there is provided a system comprising an image sensor storage and at least one processing circuitry is configured to:
acquire a textual content from a user, using a virtual human interaction agent;
acquire a visual input pertaining to the user from the image sensor;
use at least one processing circuitry for executing at least one computer vision analysis function to infer a textual indication from the visual input, wherein the visual input corresponding to a non-verbal cue; and
generate at least one prompt by processing the textual content and the textual indication using the at least one processing circuitry executing an interaction model.

According to an aspect of some embodiments of the present invention there is provided one or more computer program products comprising instructions for conducting user interaction, wherein execution of the instructions by one or more processors of a computing system is to cause a computing system to:
acquire a textual content from a user, using a virtual human interaction agent;
acquire a visual input pertaining to the user from an image sensor;
use at least one processing circuitry for executing at least one computer vision analysis function to infer a textual indication from the visual input, wherein the visual input corresponding to a non-verbal cue; and
generate at least one prompt by processing the textual content and the textual indication using the at least one processing circuitry executing an interaction model.

Optionally, the visual input comprising a user's face.

Optionally, the at least one computer vision method comprising estimating at least one face muscle positions in the user's face.

Optionally, the at least one computer vision method comprising estimating a gaze direction of the user.

Optionally, the at least one prompt comprising an element expected to cause an expected range of facial gestures.

Optionally, further comprising:
acquiring an additional visual input pertaining to the user;
using the at least one processing circuitry for executing the at least one computer vision analysis function to infer an additional textual indication from the additional visual input; and
generating at least one additional prompt by processing the additional textual indication using the at least one processing circuitry executing an interaction model.

Optionally, the at least one additional prompt is a hint aimed at clarifying the at least one prompt.

Optionally, the interaction model comprising a conversational language model.

Optionally, wherein the textual content is received from the user as a voice input, and further comprising converting the voice to text using a text extraction module.

Optionally, further comprising applying synchronizing of the textual indication and the textual content, corresponding to respective timing of the visual input and the voice input.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for conducting multimodal conversation, according to some embodiments of the present disclosure;

FIG. 2 is a schematic diagram of a simplified exemplary text and face based interaction module, according to some embodiments of the present disclosure;

FIG. 3 is a flowchart of an exemplary process for text and face based interaction, according to some embodiments of the present disclosure;

FIG. 4 is a schematic illustration of an exemplary multimodal tuition session according to some embodiments of the present disclosure; and

FIG. 5 is a schematic illustration of an exemplary multimodal interaction with a vending machine, according to some embodiments of the present disclosure.

### DESCRIPTION OF SPECIFIC EMBODIMENTS OF THE INVENTION

The present invention, in some embodiments thereof, relates to user input classification, and, more particularly, but not exclusively, to combining textual and visual input from a user.

Interaction with an automated agent, a chat-bot, may be limited to what is explicitly stated. Since reading emotional subtext from a conversation may be beneficial for many applications, some of these systems incorporate sentiment analysis, for detecting, for example when the user or customer is angry, afraid, happy, or the like, and adapt further interaction according to it.

Some embodiments of the present disclosure process the conversation using a model comprising a large language model (LLM) wherein indications based on visual input are incorporated to the model input. For example, facial gestures may indicate happiness, sadness, anger, but also confusion, alertness, focus, boredom, dizziness, specific part of the display the user is looking, and/or the like.

Some embodiments of the present disclosure apply interpretations of facial gestures such as face muscle positions, eyelid pose, pupil position, head position, and/or the like. Some implementations may identify patterns of the over time (where they may change in some pattern).

Some embodiments of the present disclosure use interpretations of facial gestures to indicate sentiments like happiness, sadness, anger, but also confusion, alertness, focus, boredom, dizziness, as well as specific objects or parts of the display the user is looking at, and/or the like.

Some embodiments of the present disclosure apply an interaction model which may resemble a chatbot, which may store former interactions and may be adapted to the interaction propose and/or user explicit and implicit requests. Some embodiment of the present disclosure apply methods of mental state assessment from facial gestures can assess mental state and thus interact with the dialog system

Some embodiments of the present disclosure process the conversation using a model comprising a large language model (LLM) wherein indications based on visual input are incorporated to the model input. For example, facial gestures may indicate happiness, sadness, anger, but also confusion, alertness, focus, boredom, dizziness, specific part of the display the user is looking, and/or the like.

Some embodiments of the present disclosure enable automating response to gestures and emotional subtext indicated thereby. Some embodiments of the present disclosure also adapt to unexpected frequently occurring emotional and interaction patterns, both for a single customer or a group and propose clustering based thereupon. These patterns may be used to further tailor user experience, assess biases, and detect concurrent or general trends.

Some embodiments of the present invention feed a language model with combination of questions, prompts, explicit user input, and implicit input obtained from visual input and use inferences generated thereby for the next steps interaction steps, applying mental state assessment from facial gestures for better interaction with the dialog system.

Some embodiments of the present invention may inject text or audiovisual events such as images, sounds, videos, and/or the like to cause an expected range of facial gestures to better assess the effectiveness of the dialog.

Some embodiments of the present invention provide automating response to gestures and emotional subtext indicated thereby. Some embodiments of the present invention may be also used to find unexpected frequently occurring emotional and interaction patterns, both for a single customer or a group and propose clustering based thereupon. These patterns may be used to further tailor user experience, assess biases, and detect trends.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

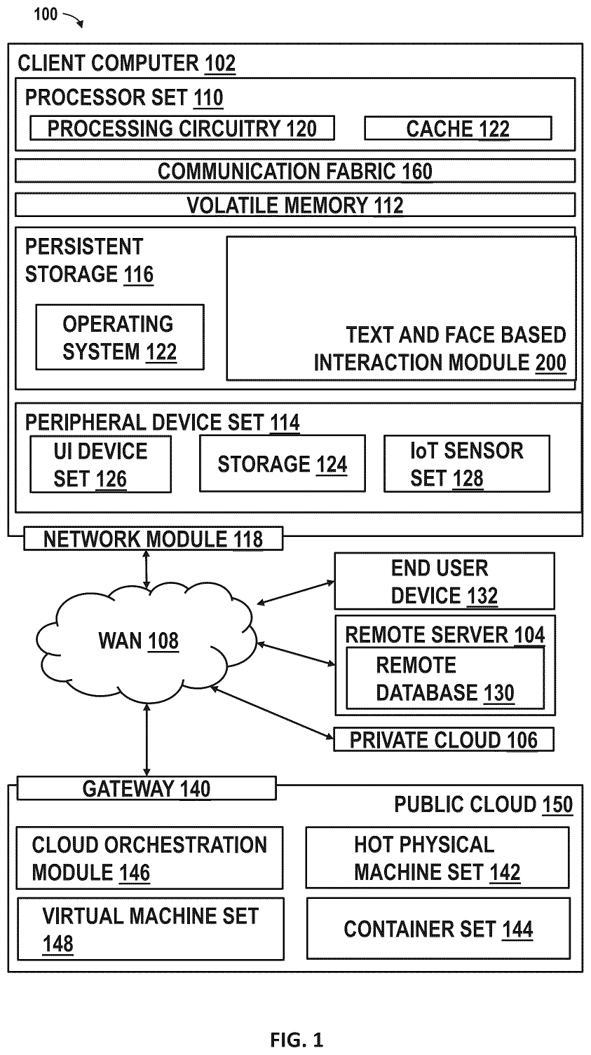

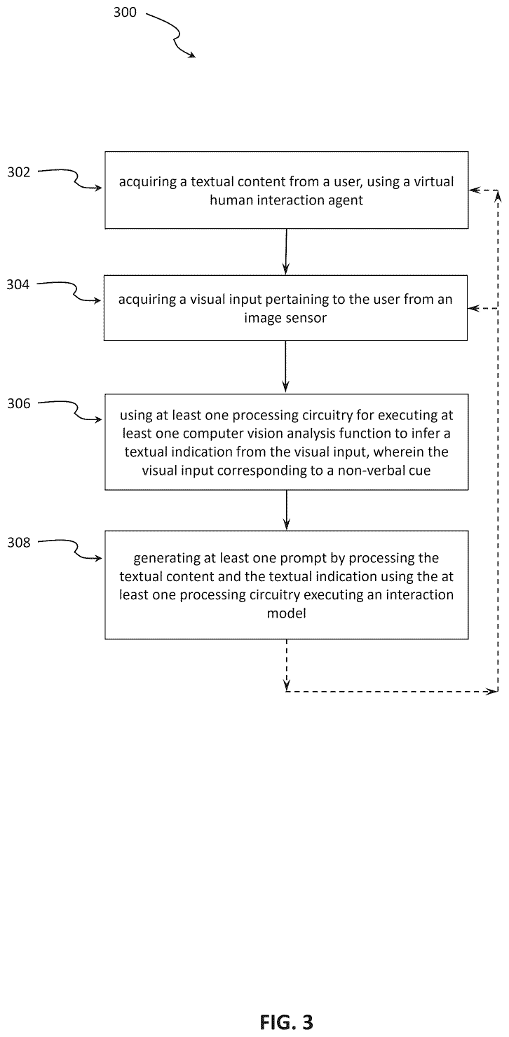

Referring now to the drawings, FIG. 1 is a schematic illustration of an exemplary system for conducting multimodal conversation, according to some embodiments of the present disclosure. An exemplary client computer system 100 may be used for executing execute processes such as 300 for text classification. Further details about these exemplary processes follow as FIG. 3 are described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as text and face based interaction module 200. In addition to block 200, computing environment 100 includes, for example, computer 102, wide area network (WAN) 108, end user device (EUD) 132, remote server 104, public cloud 150, and private cloud 106. In this embodiment, computer 102 includes processor set 110 (including processing circuitry 120 and cache 134), communication fabric 160, volatile memory 112, persistent storage 116 (including operating system 122 and block 200, as identified above), peripheral device set 114 (including user interface (UI), device set 126, storage 124, and Internet of Things (IoT) sensor set 128), and network module 118. Remote server 104 includes remote database 130. Public cloud 150 includes gateway 140, cloud orchestration module 146, host physical machine set 142, virtual machine set 148, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. For example, a processor set may include one or more of a central processing unit (CPU), a microcontroller, a parallel processor, supporting multiple data such as a digital signal processing (DSP) unit, a graphical processing unit (GPU) module, and the like, as well as optical processors, quantum processors, and processing units based on technologies that may be developed in the future. Processing circuitry 120 may be distributed over multiple packages, for example, multiple, coordinated integrated circuit chips. Processing circuitry 120 may implement multiple processor threads and/or multiple processor cores. Cache 134 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 134 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 116.

COMMUNICATION FABRIC 160 is the signal conduction paths that allow the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 116 is any form of non-volatile storage for computers that is now known or to be developed in the future. The non-volatility of this storage means that the stored data is maintained regardless of whether power is being supplied to computer 102 and/or directly to persistent storage 116. Persistent storage 116 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 126 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 128 is made up of sensors that can be used in Internet of Things applications. For example, one sensor may be a thermometer and another sensor may be a motion detector.

NETWORK MODULE 118 is the collection of computer software, hardware, and firmware that allows computer 102 to communicate with other computers through WAN 108. Network module 118 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 118 are performed on the same physical hardware device. In other embodiments (for example, embodiments that utilize software-defined networking (SDN)), the control functions and the forwarding functions of network module 118 are performed on physically separate devices, such that the control functions manage several different network hardware devices. Computer readable program instructions for performing the inventive methods can typically be downloaded to computer 102 from an external computer or external storage device through a network adapter card or network interface included in network module 118.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 132 is any computer system that is used and controlled by an end user (for example, a customer of an enterprise that operates computer 102), and may take any of the forms discussed above in connection with computer 102. EUD 132 typically receives helpful and useful data from the operations of computer 102. For example, in a hypothetical case where computer 102 is designed to provide a recommendation to an end user, this recommendation would typically be communicated from network module 118 of computer 102 through WAN 108 to EUD 132. In this way, EUD 132 can display, or otherwise present, the recommendation to an end user. In some embodiments, EUD 132 may be a client device, such as thin client, heavy client, mainframe computer, desktop computer and so on.

REMOTE SERVER 104 is any computer system that serves at least some data and/or functionality to computer 102. Remote server 104 may be controlled and used by the same entity that operates computer 102. Remote server 104 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 104.

PUBLIC CLOUD 150 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 150 is performed by the computer hardware and/or software of cloud orchestration module 146. The computing resources provided by public cloud 150 are typically implemented by virtual computing environments that run on various computers making up the computers of host physical machine set 142, which is the universe of physical computers in and/or available to public cloud 150. The virtual computing environments (VCEs) typically take the form of virtual machines from virtual machine set 148 and/or containers from container set 144. It is understood that these VCEs may be stored as images and may be transferred among and between the various physical machine hosts, either as images or after instantiation of the VCE. Cloud orchestration module 146 manages the transfer and storage of images, deploys new instantiations of VCEs and manages active instantiations of VCE deployments. Gateway 140 is the collection of computer software, hardware, and firmware that allows public cloud 150 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 150, except that the computing resources are only available for use by a single enterprise. While private cloud 106 is depicted as being in communication with WAN 108, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 150 and private cloud 106 are both part of a larger hybrid cloud.

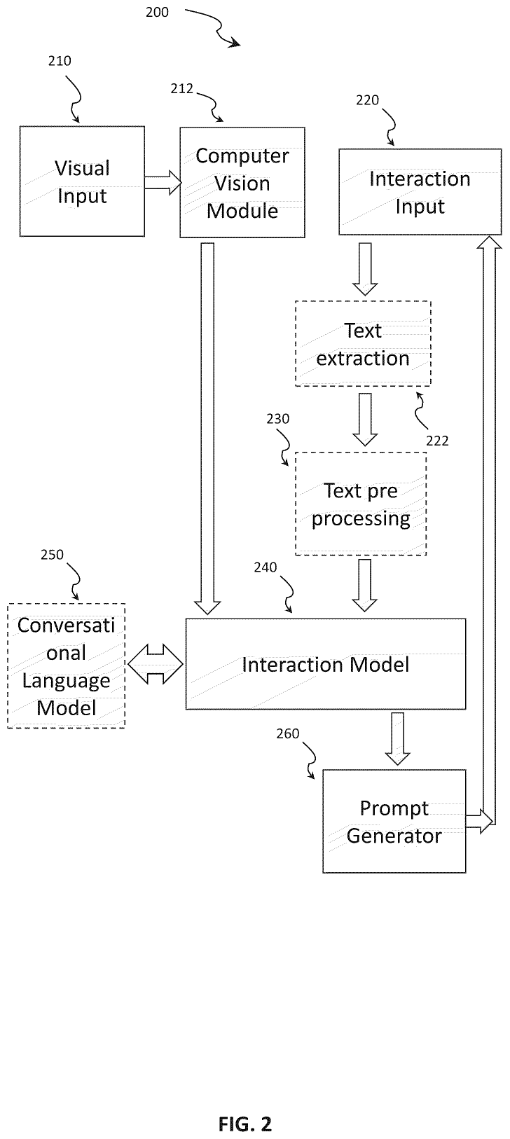

Referring now to FIG. 2, which is a schematic diagram of a simplified exemplary text and face based interaction module, according to some embodiments of the present disclosure.

The diagram describes the primary essential and optional architectural components of the text and face based interaction module 200.

The visual input 210 may be received from an end user device 132, the UI device set 126, and/or the like, and it may be a raw or compressed video clip, an optical image, an image comprising depth such as RGBD, an infrared scan, and/or the like. Optionally, a microphone may be used to accompany the video signal for multimodal processing.

The computer vision module 212 process visual input such as images or videos to infer the emotional condition of a viewed user. The module begins by receiving visual input such as 210, which may be one or more images of one or more types from one or more perspectives, frames from a video stream, and/or the like.

The input data may undergo pre-processing to enhance its quality and reduce noise. Preprocessing may include resizing, noise reduction, normalization, and/or the like.

Various computer vision methods may be used to receive non verbal cues from a user. Pose estimation, which may infer information about user physical and emotional state, involves inferring the pose or body position of the person in the image or video. The pose information may help infer the user's body language and posture, which can be indicative of their emotional state. Example algorithms for pose estimation include OpenPose which is a deep learning-based algorithm that may estimate keypoints representing the pose of a person's body, including the positions of joints like shoulders, elbows, and knees.

High-Resolution Network (HRNet) is another exemplary deep learning architecture which may be used effectively for human pose estimation, achieving state-of-the-art results. Multiscale networks such as Stacked Hourglass Network, a deep convolutional neural network architecture specifically designed for human pose estimation.

Some implementation may benefit from designing the background to improve algorithm performance, for example smooth green or blue background or tiles.

Some implementation may benefit from using more than one cameras to improve performance, for example by reducing occlusions or improving confidence in three dimensional setting. By using multiple cameras and exploiting multi-view geometry principles, it's possible to estimate the 3D pose of objects or humans with high accuracy.

Depth-sensing cameras may provide RGBD images, comprising depth information along with RGB data. This additional depth data can be used for more accurate pose estimation.

Optical motion capture systems use specialized cameras and markers placed on a subject's body to precisely capture their movements. These systems are commonly used in animation and biomechanical research. Some implementations may apply volumetric approaches such as 3D grids, voxel grids, point clouds, triangular meshes, and/or the like, to estimate the 3D pose of objects or humans.

Gesture detection involves identifying specific hand or body movements that may deliberately or accidently convey meaning or emotions, which may be valuable, non-verbal cues. Example algorithms for gesture detection include MediaPipe for hand tracking and recognizing gestures such as thumbs-up, waving, or pointing.

In some implementations the visual input comprising a user's face, and facial expression and emotional cues recognition methods, including feature-based Methods which extract facial features such as the eyes, eyebrows, mouth, and nose and analyse their configurations and movements to recognize emotions. Features like the distance between the eyes, mouth curvature, and eyebrow position may be informative. Descriptors such as SIFT, HOG or wavelet-based descriptors may be applied for feature extraction. These are some examples for computer vision method comprising face muscles positions in the user's face.

Optical flow method and background subtraction methods, separating the moving foreground from the static background in each frame, optionally using frame differencing or Gaussian Mixture Models (GMMs) may be used.

Facial Action Coding System (FACS) is an exemplary framework for categorizes facial muscle movements and describing facial expressions. It involves manual coding or automated detection of these action units to recognize emotions.

Neural networks such as Convolutional Neural Networks (CNNs) are also examples of method for estimating face and other muscles positions, and may be used for end-to-end emotion recognition by processing facial images directly. DeepFace for example is a deep learning-based algorithm that may recognize various facial expressions such as happiness, sadness, anger, and surprise.

Machine learning models comprising memory such as Long Short Term Memory (LSTM) or Recurrent Neural Networks (RNNs) may capture temporal dependencies in sequences of facial images or video frames, allowing for more accurate emotion recognition over time. Such models may be used for video gesture recognition, such as identifying and interpreting hand or body gestures in a sequence of video frames.

Hybrid Models such as models Combining CNNs and RNNs may capture both spatial and temporal information, making them suitable for video-based emotion recognition.

Depth-sensing cameras may capture 3D facial data, enabling more accurate recognition of facial expressions based on depth information. 3D Convolutional Neural Networks (3D CNNs): 3D CNNs may be used to process spatial information such as RGBD and/or temporal information.

Multimodal methods such as Audio-Visual Emotion Recognition, for example combining facial expression analysis with audio analysis, such as speech prosody and content, may provide a more holistic understanding of a person's emotional state.

Combining information from multiple sources, such as facial expressions, speech, body language, and physiological signals, may enhance the accuracy of emotion recognition.

The module may combine detected gestures, facial expressions, poses and/or the like to infer the emotional condition of the user. This may be done using rule-based systems, machine learning models, or deep learning networks trained on labeled data.

The module provides an output that indicates the emotional state of the user, such as happiness, sadness, anger, etc. This output may be in the form of labels, scores, textual descriptions, or embedded encoding.

The interaction input 220 may be received from an end user device 132, the UI device set 126, and/or the like, and it may be typed as text, a voice instruction, one or more button presses, gestures on a touchscreen, and/or the like.

For example, a food vending machine may have text describing an item associated with one or more key presses, or a virtual training session may present a screen portion and associate said portion with a text which the user may choose as an answer to a question presented. A tuition interface may be equipped, for example with a microphone, a touchscreen and/or a keyboard.

The text extraction module 222 may receive direct or indirect textual input from the user.

While key presses may be straightforward to convert to text, audio or gesture communication may require processing. Gestures on a touch screen may be processed by capturing the touch or swipe movements and identifying the patterns and shapes created by the user's finger, stylus or the like. Relevant features such as direction, speed, curvature, and shape may be extracted and classified, for example using a machine learning or rule-based models for Gesture-to-Text Conversion, some implementations may apply correction and/or user customization.

When the textual content is not entered or received as text, the text may be extracted from a voice recording, a video, and/or the like. Neural networks, transformers, autocoders, and/or the like may be used. Examples include Wav2Vec, and many Automatic Speech Recognition (ASR) modules are known. The textual content may be in a variety of languages, dialects, jargons, and the likes.

The text preprocessing 230 may filter the text to avoid weaknesses of the model, apply rules of reasonable or decent use, detect and filter noise, and/or the like. The text preprocessing may also fix weaknesses of models used when the text is extracted from a voice recording, a video, and/or the like. The textual content may be in a variety of languages, dialects, jargons, and the likes.

Some implementations of the disclosure, for example those used on languages other than English, which have lesser representation in available training data, and thus handled less effectively, may comprise a language adaptation module, for translating the textual content from a first language to a second language. Some implementations may further comprise domain specific adaptations for example in niche application.

The interaction model 240, used to implement the virtual human interaction agent, may be based on vending machine software, virtual consultants, service bots, powered by computerized agents, also used for virtual assistants. The interaction model may function as a chatbot for the purpose of examination, tutoring, emotional support, customer service, sales and or the like. The interaction model can use a variety of methods to ask questions, including knowledge representation, pre-made scripts, or artificial intelligence-based agents. Knowledge representation may be used to store and represent information in a structured way, allowing the chatbot to ask questions based on the user's responses, as well as options available to assist the user such as products available. Pre-made scripts may be used to provide a set of predetermined questions and responses, allowing the chatbot to quickly and accurately respond to the user. Artificial intelligence may be used to allow the chatbot to conduct more complex interaction, learn from the user's responses and adapt its questions and responses accordingly, and/or the like. The interaction model may also be used to provide personalized recommendations and advice to the user, based on the input provided by the user and the non-verbal cues.

Some implementations may apply synchronizing of the textual indication and the textual content, corresponding to respective timing of the visual input and the voice input, or typing of certain parts of the text. This synchronization may be used to evaluate which words convey more emotional significance, estimate the confidence level of the user in each part of the statement, and/or the like.

In some implementations the interaction model may comprise or interact with a conversational language model. The conversational language model 250 may be an artificial intelligence module designed to generate text based on a given prompt or input. The model may be an incorporated in house or third-party machine learning model, which was trained on a large corpus of text and may use deterministic or statistical techniques to generate outputs that are coherent, contextually relevant and semantically meaningful. The language model may be designed to analyze a natural language text and generate responses such as those expected in human conversation. The conversational language may be trained specifically for text classification, however models trained for variety of applications, such as chat-bots, virtual assistants, private tutor or psychotherapist emulation and customer service systems may also be used.

Conversational and other generative language models may be powered by advanced machine learning techniques, such as neural networks, and may be fine-tuned to perform specific tasks or to generate outputs in specific domains. Conversational language models may comprise components such as generative transformer network, for example for embedding a word placement in a sentence. Some generative language models comprise one or more autoregressive components, however deterministic methods may also be used.

The models may also be integrated into other systems to provide enhanced capabilities, such as improved natural language processing, text generation, and dialogue management. Followingly, the model may interact with the interaction model 240 or be included therein, thereby inferring a textual indication.

The prompt generator 260 my receive a textual indication from the interaction model and use it for generating at least one prompt. using the at least one processing circuitry executing an interaction model. The textual content may serve as a basis for the prompt generator.

Some implementations may be configured to adapt a sale conversation to an emotional state. For example, a sales interaction model may present several products while checking when the user leans forward, the user's eyes are open wide, and/or seek other indications of increased interest. Followingly the prompt may be adapted to present products or services which are more like the product presented when the use showed increased interest. Some implementation may generate interest score based on a combination of verbal and non verbal interest shown by the user and weight similarity. Some implementations may be combined with recommender systems, which may be based on collaborative filtering, proximity of products or services in embedded space, and/or the like.

Some other implementations may check for cues of confusion or low arousal, and respond to such cues with presenting the training material in a different manner adapted to different learning styles. For example, when the user seems to be confused by a logical presentation, a linguistic presentation, an interpersonal or natural analogy, and/or the like may be presented through the at least one prompt. The at least one prompt may be textual, vocal, and/or visual.

Referring now to FIG. 3, which is a flowchart of an exemplary process for text and face based interaction, according to some embodiments of the present disclosure. The processing circuitry 120 may execute the exemplary process 300 for a variety of purposes such as conducting training, operating vending machines, robotic assistants, market research, and/or the like. Alternatively, the process 300 or parts thereof may be executing using a remote system, an auxiliary system, and/or the like.

The exemplary process 300 starts, as shown in 302, with acquiring a textual content from a user, using a virtual human interaction agent.

The textual content may be directly acquired as interaction input 220 or derived therefrom using text extraction 222, and fed to the system through a user interface of the UI device set 126, network module 118, or other data input mechanism. The received text may be stored in volatile memory 112, cache, 122 peripheral storage 124, or the like, and may be followingly processed for example by the interaction model 240.

In some application, for example training oriented facilities, the input may be textual, for example typed using a keyboard. In other application, for example vending or game machines, the text may be derived form specialized keys, handles, knobs, and/or the like, or from voice input. When the textual content is received from the user as a voice input, the text extraction module 222 may convert the voice to text.

The virtual human interaction agent, which may also be referred to as a conversational agent or a dialog system, and may be implemented using an artificial intelligence method, a rule based chatbot agent, and/or the like, and may be implemented as an interaction model such as 240, or other interface methods known to the person skilled in the art. The human interaction agent may be task specific or open domain. The virtual human interaction agent may be text based, and augmented using interpretations of visual cues which may be processed as text, as embeddings, as flags, and/or the like.

The exemplary process 300 may continue, as shown in 304, with acquiring a visual input pertaining to the user from an image sensor.

The visual input, for example 210 may be received by the system through a user interface of the UI device set 126, network module 118, or other data input mechanism. The received image may be immediately processed for example by the computer vision module 212, and/or stored in volatile memory 112, cache, 122 peripheral storage 124, or the like, to be processed by the system for later processing by the computer vision module, statistics, or other applications.

The exemplary process 300 continues, as shown in 306, with using at least one processing circuitry for executing at least one computer vision analysis function to infer a textual indication from the visual input, wherein the visual input corresponding to a non-verbal cue.

The type of non-verbal cues which may be indicated by the computer vision module 212 and processed by the interaction model 240 may vary according to the application.

Some implementation may try to estimate a user arousal or attention level, for example by how open the eyes are, or how consistent the gaze toward a display is. Many computer vision methods for estimating a gaze direction of the user are known for example Pupil Labs a gaze estimation system, OpenFace and DeepGaze. Additionally, or alternatively, some applications may seek indications for confusion such as a wrinkled forehead with eyebrows drawn together, a slightly open mouth and a tilted head, scratching or tilting the head, touching the face, moving hesitantly, shrugging the shoulders, fidgeting, squinting, and/or the like.

Other implementations may estimate what kind of food or drink is likely to be preferred by a person approaching a vending machine. Other implementations may estimate how content the user is, sincerity of a message, or other notions which may be reflected in body language.

The textual indication may be fed to the interaction model as text, encoded, for example as a number ranging from 1 to 10 indicating an emotional state for example from sad to content, as an embedding, and/or the like.

The exemplary process 300 continues, as shown in 308, with generating at least one prompt by processing the textual content and the textual indication using the at least one processing circuitry executing an interaction model.

The interaction model may be based on coded rules, machine learning based chatbots, combinations thereof, or the likes. The prompts may be displayed to the user visually, vocally, by movement of mechanical components, and/or the like.

Prompts may indicate recommended products available in a vending machine, introduce and/or explain material such as an academic course or training material, and/or the like.

Some implementation may apply a sequence or a set of iterations of the process, supporting a longer, more complex, interaction. Such implementations may continue by acquiring an additional visual and/or textual input pertaining to the user, similarly to blocks 304 and/or 302 respectively.

Followingly, such implementation may use the at least one processing circuitry for executing the at least one computer vision analysis function to infer an additional textual indication from the additional visual input similarly to 306.

These implementations may generate at least one additional prompt by processing the additional textual indication using the at least one processing circuitry executing an interaction model, similarly to 308, and optionally continue further in a similar manner. For example, personalized training sessions may be dynamically adapted using many such iterations. In some of these implementations, the at least one additional prompt may ubiquitously comprise a hint aimed at clarifying the former prompt

In some of these applications the at least one prompt may comprise an element expected to cause an expected range of facial gestures. The element may be a surprise, a joke, a compliment, negative feedback, and/or the like. One of more of these consecutive iterations may respond to facial gestures or other verbal or non-verbal cues resulting from the element. For example, provide clarification when the user appears confused, or encourage the user when appearing sad.

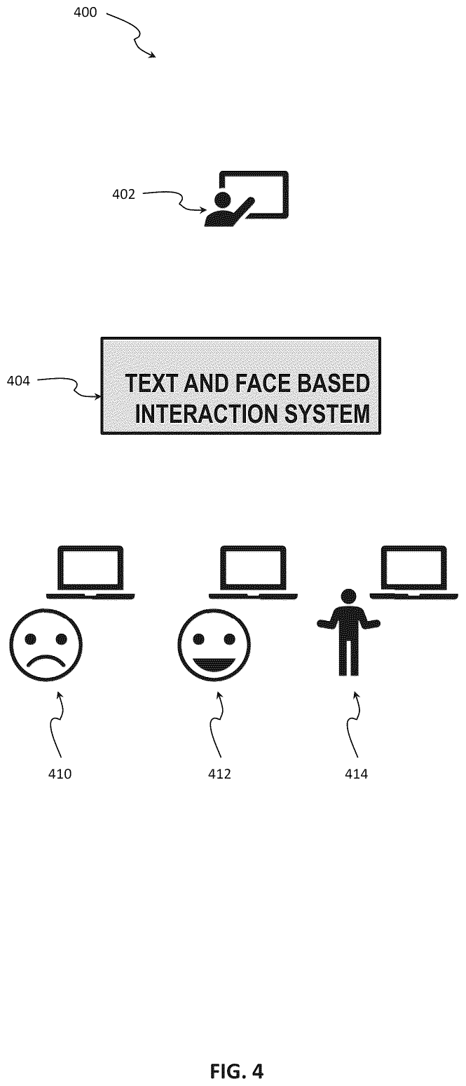

Referring now to FIG. 4, which is a schematic illustration of an exemplary multimodal tuition session according to some embodiments of the present disclosure.

The multimodal tuition session may be performed by a text and face based interaction system 404. In some implementation, the text and face based interaction system may assist a human tutor 402. The tuition session may be conducted individually or a as a group session. The tuition session may be conducted in various contexts such as school, academic studies, employee training, and/or the like.

In some implementations, the text and face based interaction system may assist an educational chatbot. The text and face based interaction system may assist a tutor or interact with a chatbot by helping indicating based on facial expressions, optionally combined with other verbal or non-verbal cues, when a user such as 410 is not content, or when a user is happy such as 412.

In some implementations, an educational chatbot may receive an indication that one or more of the students appear confused, for example 414 and may, for example repeats the last section of text in a more segmented and simpler alternative phrasing, display an infographic about relevant background knowledge, and/or the like.

In some implementations, an educational chatbot may give a student a multiple-choice question. By using information, for example from tracking the eye movement and/or other facial features the chatbot may receive indication the student may be having a hard time, and present a hint.

In some implementations, a training system may track the user head and eye/pupil motions while examining a large amount of information, measuring dwell time on each in conjunction with facial sentiment, to estimate indications about a user thought process and alertness to the most pertinent information, for example in driving or flight training. The training system may apply a dialog to cross validate conclusions such as. “Did you notice the aileron position?” or “Was the pressure in the left-wing fuel tank as expected?”. In other implementations an educational chatbot may present a list of clinical symptoms and some medical imaging visualizations, and follow where a trainee looks for findings, and follow attention and non-verbal responses.

Similar chatbots may be used for briefings, assisting meeting conductance, assisting mental therapy, and/or the like.

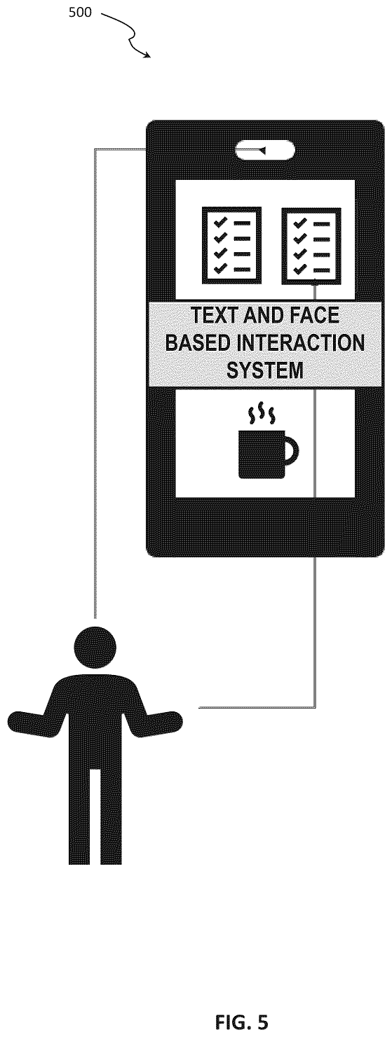

Referring now to FIG. 5, which is a schematic illustration of an exemplary multimodal interaction with a vending machine, according to some embodiments of the present disclosure.

As shown in 500 the vending machine may comprise a large display, some of which may be a touch screen, and a camera which may be placed above the display. In some implementations the display may feature button fields, images or clips of products on parts of the display, animations, and/or the like.

In addition to in interaction with buttons on the vending machine, and/or through communication with devices such as cellphones, smartwatches and/or the like, the camera may be used to trace body pose, hand gestures, general movement, facial expressions, and/or the like.

An example of a vending machine, comprising text and face based interaction system, however similar methods may be used for tuition, staff access systems, personal assistance devices, accessibility devices, and/or the like.

Such vending machines may be place in malls, work spaces, transportation hubs, and/or the like, and use audio and/or visual content to attract potential customers. A customer may activate the interaction with the vending machine be performing a manual gesture on the interface such as a tap on a touch screen, a button press, waving hand in front of a camera, and/or by a facial gesture such as eye blinking and/or the like. The vending machine may respond with a welcoming message, a vocal introduction to available products and/or a selection of dishes, sandwiches, ice cream servings, snacks, drinks, and/or the like displayed on the screen. Some implementation may present a predetermined set of products, or a menu however some implementation may adapt the menu according to visual cues detected, for example by the computer vision module, or by other methods of acquiring cues from the interaction between the customer and the vending machine. These visual cues may be used, for example to adjust proposed default levels of caffeine or sugar contents in a drink, suggest a less commonly ordered alternatives when signs of boredom are detected and/or the like. These adaptations may help the customer to explore and browse through the virtual aisles of the proposed products smoothly and effortlessly. Some implementations if the vending machine may store individual preferences and may be equipped with gait or facial recognition technology, communicate with a device held by the customer using methods such as RFID, or the like and apply user identification to personalize suggested product recommendations. User identification may also be used to support a secure method of billing.

Similarly, a computer-based sales system may, for example track the customer's facial gestures using the text and face based interaction system, as it lists the prices of options on a tour package, thus assessing the follow up negotiation and offer strategy.

It is expected that during the life of a patent maturing from this application many relevant conversational language models, text media, and representation methods will be developed and the scope of the terms conversational language models machine learning model, text, and embedding are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for evaluating understanding in a textual content, comprising:
acquiring a textual content from a user, using a virtual human interaction agent;
acquiring a visual input pertaining to the user from an image sensor;
using at least one processing circuitry for executing at least one computer vision analysis function to infer a textual indication from the visual input, wherein the visual input corresponding to a non-verbal cue; and
generating at least one prompt by processing the textual content and the textual indication using the at least one processing circuitry executing an interaction model.

2. The method of claim 1, wherein the visual input comprising a user's face.

3. The method of claim 2, wherein the at least one computer vision method comprising estimating at least one face muscle positions in the user's face.

4. The method of claim 2, wherein the at least one computer vision method comprising estimating a gaze direction of the user.

5. The method of claim 1, wherein the at least one prompt comprising an element expected to cause an expected range of facial gestures.

6. The method of claim 5, further comprising:
acquiring an additional visual input pertaining to the user;
using the at least one processing circuitry for executing the at least one computer vision analysis function to infer an additional textual indication from the additional visual input; and
generating at least one additional prompt by processing the additional textual indication using the at least one processing circuitry executing an interaction model.

7. The method of claim 6, wherein the at least one additional prompt is a hint aimed at clarifying the at least one prompt.

8. The method of claim 1, wherein the interaction model comprising a conversational language model.

9. The method of claim 1, wherein the textual content is received from the user as a voice input, and further comprising converting the voice to text using a text extraction module.

10. The method of claim 9, further comprising applying synchronizing of the textual indication and the textual content, corresponding to respective timing of the visual input and the voice input.

11. A system comprising an image sensor storage and at least one processing circuitry is configured to:
acquire a textual content from a user, using a virtual human interaction agent;
acquire a visual input pertaining to the user from the image sensor;
use at least one processing circuitry for executing at least one computer vision analysis function to infer a textual indication from the visual input, wherein the visual input corresponding to a non-verbal cue; and
generate at least one prompt by processing the textual content and the textual indication using the at least one processing circuitry executing an interaction model.

12. The system of claim 11, wherein the visual input comprising a user's face.

13. The system of claim 12, wherein the at least one computer vision method comprising estimating at least one face muscle positions in the user's face.

14. The system of claim 12, wherein the at least one computer vision method comprising estimating a gaze direction of the user.

15. The system of claim 11, wherein the at least one prompt comprising an element expected to cause an expected range of facial gestures.

16. The system of claim 15, wherein the at least one processing circuitry is further configured to:
acquire an additional visual input pertaining to the user;
use the at least one processing circuitry for executing the at least one computer vision analysis function to infer an additional textual indication from the additional visual input; and
generate at least one additional prompt by processing the additional textual indication using the at least one processing circuitry executing an interaction model.

17. The system of claim 16, wherein the at least one additional prompt is a hint aimed at clarifying the at least one prompt.

18. The system of claim 11, wherein the interaction model comprising a conversational language model.

19. The system of claim 11, wherein the textual content is received from the user as a voice input, and further comprising converting the voice to text using a text extraction module.

20. The system of claim 19, further comprising applying synchronizing of the textual indication and the textual content, corresponding to respective timing of the visual input and the voice input.

21. One or more computer program products comprising instructions for conducting user interaction, wherein execution of the instructions by one or more processors of a computing system is to cause a computing system to:
acquire a textual content from a user, using a virtual human interaction agent;
acquire a visual input pertaining to the user from an image sensor;
use at least one processing circuitry for executing at least one computer vision analysis function to infer a textual indication from the visual input, wherein the visual input corresponding to a non-verbal cue; and
generate at least one prompt by processing the textual content and the textual indication using the at least one processing circuitry executing an interaction model.
